(19) United States
(12) Patent Application Publication
(10) Pub. No.: US 2025/0237374 A1
(43) Pub. Date: Jul. 24, 2025

(54) Stage Light With Heat Dissipation

(71) Applicant: TaoTao Liu, Lianyuan (CN)

(72) Inventors: TaoTao Liu, Lianyuan (CN); Weibo Xie, Ji'an City (CN)

(21) Appl. No.: 18/826,087

(22) Filed: Sep. 5, 2024

(30) Foreign Application Priority Data
Jan. 20, 2024 (CN) 2024201444615

(51) Int. Cl. F21V 29/70; F21W 131/406; F21Y 113/00; F21Y 115/10

(52) U.S. Cl. CPC F21V 29/70; F21W 2131/406; F21Y 2113/00; F21Y 2115/10

(57) ABSTRACT

A stage light with heat dissipation is disclosed, including a base and a stage light body. The base is provided with a Y-axis arm capable of rotating, and the Y-axis arm is provided with a Z-axis arm capable of pitching motion. The stage light body includes a lampshade and an upper cover plate attached on the lampshade, the upper cover plate is rotationally connected to a bottom of the Z-axis arm. The lampshade is provided with a radiator unit inside, the radiator unit is provided with a number of LED light source boards on a periphery thereon, and the LED light source boards are provided with LED light sources. The lampshade is further provided with openings on the periphery corresponding to positions of the LED light source boards, and optical lens are mounted in the openings by means of optical limit frames.

### TECHNICAL FIELD

The present application relates to the technical field of stage lights, and in particular to a stage light with heat dissipation.

### BACKGROUND

In existing technologies, an adjustment structure of a stage light usually adopts a simple rotation design, which limits its adjustment range in the Y-axis and Z-axis directions. Such a design can not to meet the needs of complex stage effects, and therefore limits the creative expressiveness of lighting.

In addition, in terms of heat dissipation, some stage lights in the existing technologies are use a traditional heat dissipation design with a small heat dissipation area, which has a poor heat dissipation effect on LED light sources. This leads to an increase in temperature and a decrease in power of the LED light sources when working for a long time, and even may affect the life and stability of the product.

### SUMMARY

The present disclosure aims to provide a stage light with heat dissipation to address technical problems mentioned above.

To solve the above technical problems, the present disclosure adopts following technical solutions. In some embodiments of the present disclosure, a stage light with heat dissipation is provided, including a base and a stage light body. Herein the base is provided with a Y-axis arm capable of rotating, and the Y-axis arm is provided with a Z-axis arm capable of pitching motion. The stage light body includes a lampshade and an upper cover plate attached on the lampshade, the upper cover plate is rotationally connected to a bottom of the Z-axis arm. The lampshade is provided with a radiator unit inside, the radiator unit is provided with a number of LED light source boards on a periphery thereon, and the LED light source boards are provided with LED light sources. The lampshade is further provided with openings on the periphery corresponding to positions of the LED light source boards, and optical lens are mounted in the openings by means of optical limit frames.

Preferably, the base is provided with a cavity inside, the cavity is provided with a U-shaped plate, the Y-axis arm is rotationally connected to the U-shaped plate through a first gear shaft, a first motor is disposed on bottom of the U-shaped plate, a first drive wheel is provided on an output shaft of the first motor, and the first drive wheel is engaged with the first gear shaft via a first conveyor.

Preferably, the Z-axis arm is rotationally connected to a side of the Y-axis arm by means of a second gear shaft, the Z-axis arm is provided with a second motor inside, a second drive wheel is provided on an output shaft of the second motor, and the second drive wheel is engaged with the second gear shaft via a second conveyor.

Preferably, the upper cover plate on the lampshade is rotationally connected to the bottom of the Z-axis arm by means of a third gear shaft, the Z-axis arm is provided with a third motor inside, a third drive wheel is provided on an output shaft of the third motor, and the third drive wheel is engaged with the third gear shaft via a third conveyor.

Preferably, the radiator unit includes a hexagonal heat dissipation body, the hexagonal heat dissipation body is provided with a heat dissipation chamber in middle and the heat dissipation chamber is provided with a number of radiation ribs on inner peripheral wall, six corners of the hexagonal heat dissipation body are provided with connection plates, and the hexagonal heat dissipation body is installed on bottom of the upper cover plate through the connection plates, the number of the LED light source boards is set to six and are installed on six sides of the hexagonal heat dissipation body, respectively.

Preferably, the lampshade is internally provided with a cooling fan located underneath the hexagonal heat dissipation body, and the lampshade is provided with a number of heat dissipation holes on upper and lower surfaces.

Preferably, the lampshade is fitted with dust shields on the upper and lower surfaces.

The stage light with heat dissipation of the present disclosure has at least following advantages compared with the existing technologies. Firstly, by designing of components such as the base, the Y-axis arm, Z-axis arm and the lampshade, it is possible to realize multi-directional adjustment of the stage light body, including the rotation of the Y-axis arm, the pitching motion of the Z-axis arm, as well as the rotation of stage light body, so as to realize the flexible positioning of the LED light sources and provide a wide range of options for different stage effects. Secondly, for the radiator unit, it designs the hexagonal heat dissipation body, and combines with the internal heat dissipation chamber and radiation ribs to improve the structural strength of the entire radiator unit. Six LED light source boards are mounted on six sides of the hexagonal heat dissipation body, and with designs of the cooling fan and the heat dissipation holes inside the lampshade, realizing fast and effective heat dissipation. In addition, the dust shields can prevent dust from affecting the work of the lampshade's internal components, increasing the stability and life of product. In terms of working principle, the stage light of the present disclosure can meet the requirements of full power illumination of multiple LED light sources in case of small heat dissipation area. When the LED light sources alone or partially luminous, the radiator unit can effectively dissipate heat to keep the power of the LED light sources does not decrease. When all the LED light sources luminous at the same time, through reasonable heat dissipation design, this can ensure stable operations of the product and also avoid the power reduction caused by overheating.

Therefore, the stage light with heat dissipation of the present disclosure has a flexible adjustment structure and a highly efficient heat dissipation design, which can meet the needs of different stage effects, and meanwhile also can ensure the stability and long life of the LED light sources, and thus has a large market application prospect.

### BRIEF DESCRIPTION OF THE DRAWINGS

FIG. 1 shows a structural schematic diagram of a stage light with heat dissipation in accordance with some embodiments of the present disclosure.

FIG. 2 shows a partial split structural schematic diagram of the stage light with heat dissipation in accordance with some embodiments of the present disclosure.

FIG. 3 shows a partial exploded view of the stage light with heat dissipation in accordance with some embodiments of the present disclosure.

In the drawings, reference signs are as follows. 1. Base, 2. Y-axis arm, 3. Z-axis arm, 4. Lampshade, 5. Upper cover plate, 6. LED light source board, 7. LED light source, 8. Optical limit frame, 9. Optical lens, 10. U-shaped plate, 11. First gear shaft, 12. First motor, 13. First drive wheel, 14. Second gear shaft, 15. Second motor, 16. Second drive wheel, 17. Third gear shaft, 18. Third motor, 19. Third drive wheel, 20. Hexagonal heat dissipation body, 21. Radiation rib, 22. Connection plate, 23. Cooling fan, 24. Heat dissipation hole, 25. Dust shield.

### DETAILED DESCRIPTION OF THE EMBODIMENTS

The stage light with heat dissipation of the present disclosure will be described in further detail below in conjunction with the accompanying drawings.

Specific embodiments of the present disclosure are described in further detail below in conjunction with the accompanying drawings. Herein identical parts are indicated by the same reference signs.

It is should be noted that the terms “front”, “back”, “left”, “right”, “up” and “down” as used in the following description refer to directions in the accompanying drawings, and the terms “inside” and “outside” refer to directions toward or away from the geometric center of a particular component, respectively.

In order to make the contents of the present disclosure easier to be clearly understood, the technical solutions in the embodiments of the present disclosure will be clearly and completely described below in conjunction with the accompanying drawings in the embodiments of the present disclosure.

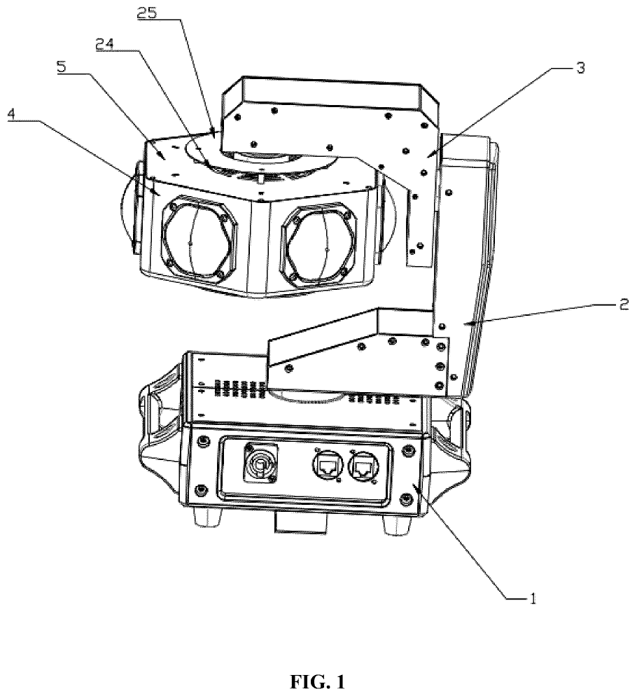

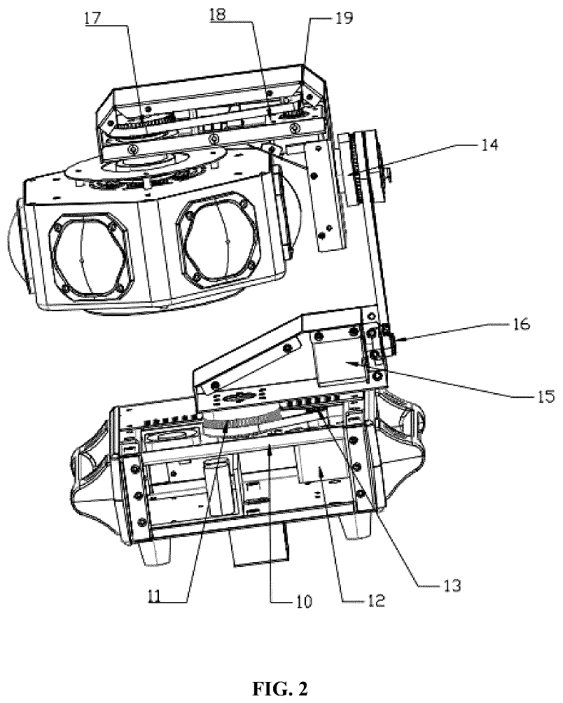

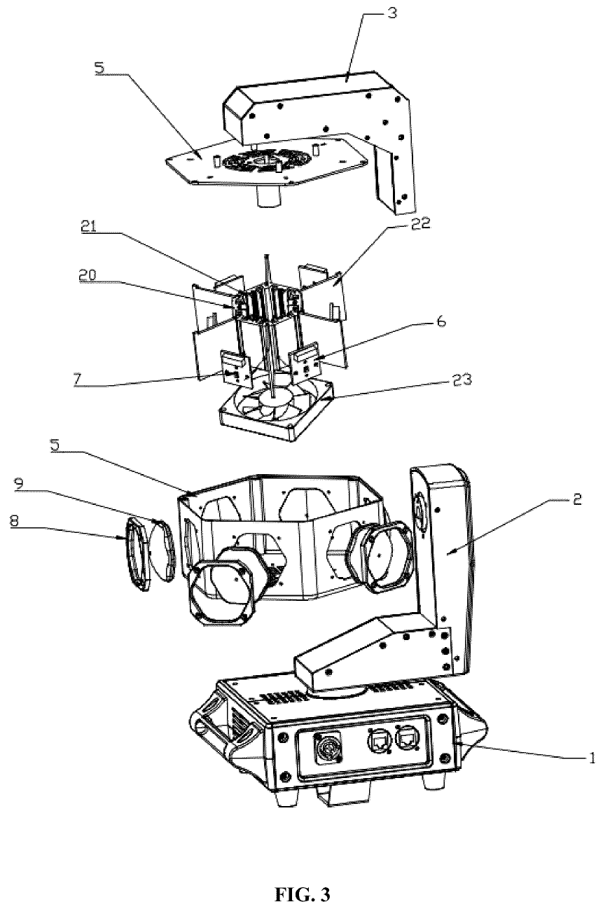

Referring to FIG. 1 to FIG. 3, in some embodiments of the present disclosure, a stage light with heat dissipation is provided, including a base 1 and a stage light body. Herein the base 1 is provided with a Y-axis arm 2 capable of rotating, and the Y-axis arm 2 is provided with a Z-axis arm 3 capable of pitching motion. The stage light body includes a lampshade 4 and an upper cover plate 5 attached on the lampshade 4, the upper cover plate 5 is rotationally connected to a bottom of the Z-axis arm 3. The lampshade 4 is provided with a radiator unit inside, the radiator unit is provided with a number of LED light source boards 6 on a periphery thereon, and the LED light source boards 6 are provided with LED light sources 7. The lampshade 4 is further provided with openings on the periphery corresponding to positions of the LED light source boards 6, and optical lens are mounted in the openings by means of optical limit frames.

In some embodiments of the present disclosure, in order to achieve the rotate of the Y-axis arm 2 to adjust the position of the LED light sources 7, the base 1 is provided with a cavity inside and the cavity is provided with a U-shaped plate 10, the Y-axis arm 2 is rotationally connected to the U-shaped plate 10 through a first gear shaft 11, a first motor 12 is disposed on bottom of the U-shaped plate 10, a first drive wheel 13 is provided on an output shaft of the first motor 12, and the first drive wheel 13 is engaged with the first gear shaft 11 via a first conveyor. Starting the first motor 12, then the first motor 12 drives the rotation of the first drive wheel 13, and the first drive wheel 13 cooperates with the first conveyor to drive the rotation of the first gear shaft 11, which can drive the rotation of the Y-axis arm 2 to adjust the position of the LED light sources 7.

In some embodiments of the present disclosure, in order to achieve the pitching motion of the Z-axis arm 3 to adjust the position of the LED light sources 7, the Z-axis arm 3 is rotationally connected to a side of the Y-axis arm 2 by means of a second gear shaft 14, the Z-axis arm 2 is provided with a second motor 15 inside, a second drive wheel 16 is provided on an output shaft of the second motor 15, and the second drive wheel 16 is engaged with the second gear shaft 14 via a second conveyor. Starting the second motor 15 to drive the second drive wheel 16 to rotation, the second drive wheel 16 cooperates with the second conveyor to drive the pitching motion of the Z-axis arm 3 to adjust the position of the LED light sources 7.

In some embodiments of the present disclosure, in order to achieve the rotation of stage light body, the upper cover plate 5 on the lampshade 4 is rotationally connected to the bottom of the Z-axis arm 3 by means of a third gear shaft 17, the Z-axis arm 3 is provided with a third motor 18 inside, a third drive wheel 19 is provided on an output shaft of the third motor 18, and the third drive wheel 19 is engaged with the third gear shaft 17 via a third conveyor. Starting the third motor 18, then the third motor 18 drives the third drive wheel 19 to rotation, the third drive wheel 19 cooperates with the third conveyor to drive the rotation of the third gear shaft 17 and the stage light body. Thus stage light with heat dissipation of the present disclosure can adjust the position of the LED light sources 7 in multiple directions to realize different stage effects.

In some embodiments of the present disclosure, the radiator unit includes a hexagonal heat dissipation body 20, the hexagonal heat dissipation body 20 is provided with a heat dissipation chamber in middle and the heat dissipation chamber is provided with a number of radiation ribs 21 on inner peripheral wall, six corners of the hexagonal heat dissipation body 20 are provided with connection plates 22, and the hexagonal heat dissipation body 20 is installed on bottom of the upper cover plate 5 through the connection plates 22. The connection plates 22 are symmetrically distributed to enhance the strength of the connection between the hexagonal heat dissipation body 20 and the upper cover plate 5, which can increase the structural strength of the entire radiator unit. The number of the LED light source boards 6 is set to six and are installed on six sides of the hexagonal heat dissipation body 20, respectively.

In some embodiments of the present disclosure, for rapid heat dissipation of the hexagonal heat dissipation body 20, the lampshade 4 is internally provided with a cooling fan 23 located underneath the hexagonal heat dissipation body 20, and the lampshade 4 is provided with a number of heat dissipation holes 24 on upper and lower surfaces. When the heat generated by the LED light source boards 6 in working is transferred to the hexagonal heat dissipation body 20, by turning on the cooling fan 23, the cooling fan 23 can draw the outside air into the inside of the lampshade 4 through the heat dissipation holes 24 on the lower surface of the lampshade 4, and rapidly dissipate heat from the radiation ribs 21 through the heat dissipation chamber in the middle of the heat dissipation body 20.

In some embodiments of the present disclosure, the lampshade 4 is fitted with dust shields 25 on the upper and lower surfaces. The dust shields 25 can prevent dust from entering the inside of the lampshade 4 through the heat dissipation holes 24 and affecting the operation of the components inside of the lampshade 4.

Working principle of the stage light with heat dissipation of the present disclosure is described as follows. Six or more independent LED light source boards 6 are fixed to the sides of the radiator unit having a hexagonal or polygonal shape, when the heat generated by the LED light source boards 6 in working is transferred to the hexagonal heat dissipation body 20, the cooling fan 23 is turned on, the cooling fan 23 can draw the outside air into the inside of the lampshade 4 through the heat dissipation holes 24, and rapidly dissipate heat from the radiation ribs 21 through the heat dissipation chamber in the middle of the hexagonal heat dissipation body 20. During the working process of such product, when one LED light source 7 emits light independently, or when multiple LED light sources 7 emit light together (not including all LED light sources 7), the radiator unit can meet the heat dissipation requirements and keep the LED light sources 7 not lowering the power. When all the LED light sources 7 emit light at the same time, and the temperature of the radiator unit reaches a certain height, the LED light sources 7 will reduce the power to ensure the stability of the product. Therefore, the stage light with heat dissipation of the present disclosure can satisfy as many LED light sources 7 as possible to emit full power in a case of maintaining a small heat dissipation area.

The foregoing description, for purpose of explanation, has been described with reference to specific embodiments. However, the illustrative discussions above are not intended to be exhaustive or to limit the scope of the claims to the precise forms disclosed. Any modifications and variations made by one person of ordinary skill in the art based on the technical solutions of the present disclosure, without departing from the concept of the present disclosure, shall be covered by the scope of protection of the present invention.

What is claimed is:

1. A stage light with heat dissipation, comprising a base (1) and a stage light body;
wherein the base (1) is provided with a Y-axis arm (2) capable of rotating, and the Y-axis arm (2) is provided with a Z-axis arm (3) capable of pitching motion;
wherein the stage light body comprises a lampshade (4) and an upper cover plate (5) attached on the lampshade (4), the upper cover plate (5) is rotationally connected to a bottom of the Z-axis arm (3);
wherein the lampshade (4) is provided with a radiator unit inside, the radiator unit is provided with a number of LED light source boards (6) on a periphery thereon, and the LED light source boards (6) are provided with LED light sources (7); and
wherein the lampshade (4) is further provided with openings on the periphery corresponding to positions of the LED light source boards (6), and optical lens are mounted in the openings by means of optical limit frames.

2. The stage light with heat dissipation according to claim 1, wherein the base (1) is provided with a cavity inside and the cavity is provided with a U-shaped plate (10), the Y-axis arm (2) is rotationally connected to the U-shaped plate (10) through a first gear shaft (11), a first motor (12) is disposed on bottom of the U-shaped plate (10), a first drive wheel (13) is provided on an output shaft of the first motor (12), and the first drive wheel (13) is engaged with the first gear shaft (11) via a first conveyor.

3. The stage light with heat dissipation according to claim 1, wherein the Z-axis arm (3) is rotationally connected to a side of the Y-axis arm (2) by means of a second gear shaft (14), the Z-axis arm (2) is provided with a second motor (15) inside, a second drive wheel (16) is provided on an output shaft of the second motor (15), and the second drive wheel is engaged with the second gear shaft (14) via a second conveyor.

4. The stage light with heat dissipation according to claim 1, wherein the upper cover plate (5) on the lampshade (4) is rotationally connected to the bottom of the Z-axis arm (3) by means of a third gear shaft (17), the Z-axis arm (3) is provided with a third motor (18) inside, a third drive wheel (19) is provided on an output shaft of the third motor (18), and the third drive wheel (19) is engaged with the third gear shaft (17) via a third conveyor.

5. The stage light with heat dissipation according to claim 1, wherein the radiator unit comprises a hexagonal heat dissipation body (20), the hexagonal heat dissipation body (20) is provided with a heat dissipation chamber in middle and the heat dissipation chamber is provided with a number of radiation ribs (21) on inner peripheral wall, six corners of the hexagonal heat dissipation body (20) are provided with connection plates (22), and the hexagonal heat dissipation body (20) is installed on bottom of the upper cover plate (5) through the connection plates (22), the number of the LED light source boards (6) is set to six and are installed on six sides of the hexagonal heat dissipation body (20), respectively.

6. The stage light with heat dissipation according to claim 5, wherein the lampshade (4) is internally provided with a cooling fan (23) located underneath the hexagonal heat dissipation body (20), and the lampshade (4) is provided with a number of heat dissipation holes (24) on upper and lower surfaces.

7. The stage light with heat dissipation according to claim 6, wherein the lampshade (4) is fitted with dust shields (25) on the upper and lower surfaces.
